(19) United States
(12) Patent Application Publication
(10) Pub. No.: US 2005/0185102 A1
(43) Pub. Date: Aug. 25, 2005

(54) Single touch launch of remote applications over video

(76) Inventor: Jon A. Fairhurst, Camas, WA (US)

Correspondence Address: MARGER JOHNSON & MCCOLLOM, P.C. - SHARP, 1030 SW MORRISON STREET, PORTLAND, OR, 97205, US

(21) Appl. No.: 10/976,389

(22) Filed: Oct. 29, 2004

Related U.S. Application Data
(60) Provisional application No. 60/535,188, filed on Jan. 6, 2004.

(51) Int. Cl. H04N 5/44

(52) U.S. Cl. 348/734; 340/815.6

(57) ABSTRACT

The current invention describes a remote display technology which, responsive to button activations from a wireless remote control to a television display device, routes signals to a host computer to activate the application button responsive to the specific remote control button pressed with the application appearing on the television display.

### CROSS-REFERENCES TO RELATED APPLICATIONS.

This application claims the benefit from U.S. Provisional Patent Application No. 60/535,188 filed Jan. 6, 2004 whose contents are incorporated herein for all purposes.

### BACKGROUND OF THE INVENTION

1. Field of the Invention

The invention relates to computer applications that are run on one machine and displayed on another; and more particularly to the case where the display is a television that displays the application over video.

2. Description of the Prior Art

The problem is how to run large applications on the television, without needing to add expensive computing resources to the television, while retaining the ability to activate an application at the touch of a single button. One solution would be to run the application remotely, using Remote Desktop Protocol (RDP) or some other remote display technology. The prior art, however, does not provide for such applications to be selected at the touch of a button. Current remote display technologies instead provide for generic inputs, such as mouse and keyboard events, to be sent from the remote display to the host computer. These technologies do not have provisions for applications to be selected at the touch of a single, dedicated button.

Accordingly, the need remains for a simulator that overcomes these drawbacks in the prior art.

### SUMMARY OF THE INVENTION

The current invention describes a remote display technology which, responsive to button activations from a wireless remote control to a television display device, routes signals to a host computer to activate the application button responsive to the specific remote control button pressed with the application appearing on the television display.

The foregoing and other objects, features and advantages of the invention will become more readily apparent from the following detailed description of a preferred embodiment of the invention that proceeds with reference to the accompanying drawings.

### BRIEF DESCRIPTION OF THE DRAWINGS

FIG. 1 is a block diagram showing operation of a remote display according to techniques known in the prior art.

FIG. 2 is a block diagram showing the operation of a remote display according to techniques implemented according to the present invention.

FIG. 3 is a schematic diagram of a preferred remote control device used with the display of FIG. 2.

FIG. 4 is a screen image interface operable on the remote display of FIG. 2 to assign program function keys according to an alternate embodiment of the invention.

FIG. 5 is a block diagram showing a more detailed implementation of the television system constructed to implement the present invention.

FIG. 6 is a flow diagram showing operation of the invention according to a preferred embodiment of the invention.

### DETAILED DESCRIPTION

This invention adds an additional channel of information to existing protocols for displaying computer screens on a remote display, herein referred to as “remote display technology”. Examples of existing solutions include Independent Computer Architecture (ICA) from Citrix, Remote Desktop Protocol (RDP) from Microsoft, Virtual Network Computing (VNC) from AT&T, PCAnywhere from Symantec, and PC@TV from RF Link Technologies. Each of these solutions encodes a picture of a graphical display and sends it to a remote device where the picture is decoded and presented to the user on a display (e.g. computer monitor) operated by the remote device (e.g. remote computer). The user may enter keystrokes or mouse actions at the remote device. These actions are sent back to the computer generating the image, which then reacts as programmed. The user experience is that of using a normal computer; however, the actual computer may be far away from the user.

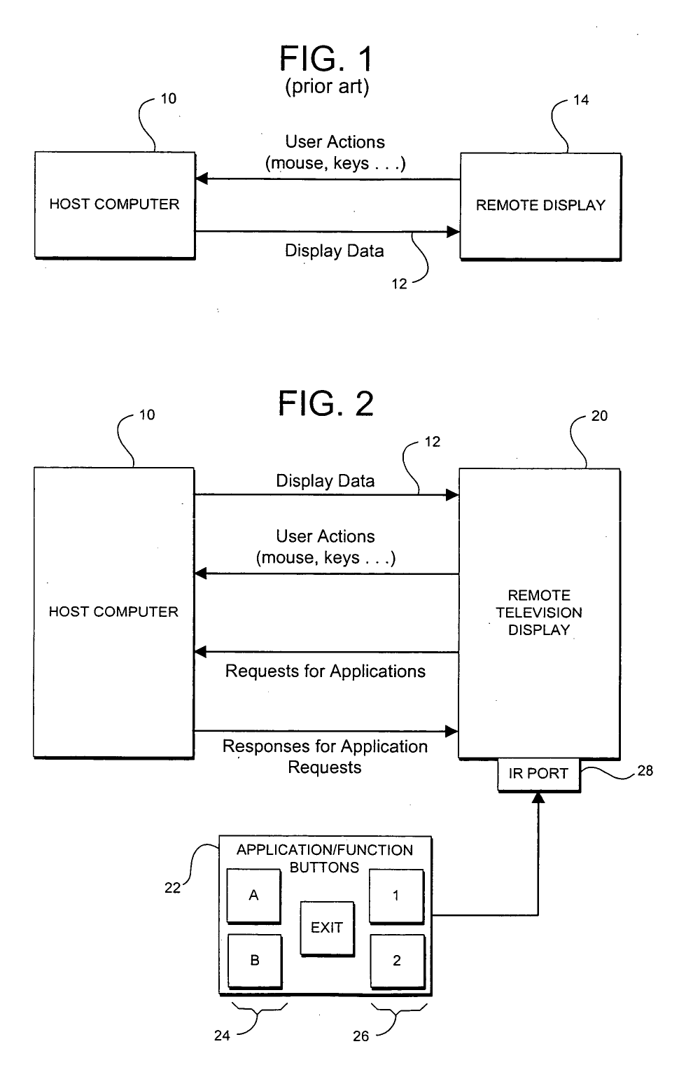

The computer which runs the application is called the “host computer,” and the remote display viewed by the user is called the “remote display.” These prior art systems are shown schematically in the block diagram shown in FIG. 1 with host computer 10 sending display data along connector 12 (e.g. direct-line, bi-directional modem connection) to remote display 14, which in turn sends user actions such as mouse movements and keys strikes along the same bi-directional connection.

FIG. 2 illustrates a television system display 20 operable with the host computer 10 according to the present invention. Television systems present a slightly different environment than a computer. The television typically has no mouse or keyboard, but does have a remote control. The typical remote control buttons, however, map to keyboard events. Examples are “up”, “down”, “left”, “right”, “0 through 9”, and the “enter” button. Unlike standard keyboards, however, television remote controls may also have dedicated buttons. Typically these dedicated buttons access local applications (i.e. those that operate directly on the television), such as an Electronic Program Guide (EPG) or configuration menu.

As with the prior art system shown in FIG. 1, the remote television display 20 may receive display data from a host computer 10 and send user actions such as mouse movements and key stokes to the host computer using existing remote display technology programs operable on both the television and the host computer. The remote television display 20 further includes a set of application/function buttons, located at the display, which may be implemented as a remote control 22 for the television 20, or as buttons defined on the television casing itself. The remote control 22 has local application buttons 24 which operate functions of the television such as volume and channel selection. The remote control 22 also has non-local application buttons 26 which trigger requests for applications to host computer 10, and responses from the host computer back to the remote television display 20.

The remote control includes a housing, buttons formed through the housing with lower surfaces adapted to make electrical contact to complete a circuit on a circuit board positioned beneath the buttons within the housing. When the viewer presses a button on the remote control this completes a specific connection. An IC chip located on the circuit board senses that connection and knows what button was pressed. The IC chip then produces a signal formed of a series of binary pulses specific to that button. That signal is amplified by transistors within the housing and the amplified signal is sent to an infrared LED, which translates the signal into infrared light. The sensor 28 in the TV can see the infrared light and “seeing” the signal reacts appropriately.

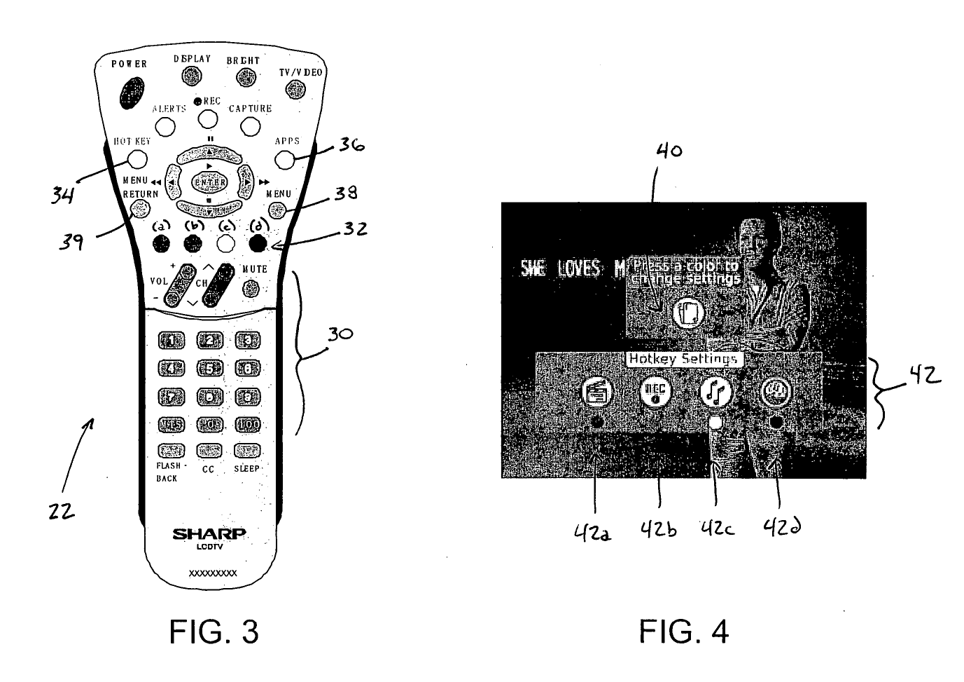

FIG. 3 shows one implementation of a remote control 22 used to implement the invention. The remote control in FIG. 3 includes many local-function buttons 30, examples of which are the number keys 0-9, the volume up/down button, and the channel up/down button. The remote control further has plurality of non-local function keys. Each key, when depressed, activates a wireless signal (here an infrared signal) to be transmitted from the remote control. Each button activates a unique series binary code that is transmitted by way of the wireless signal. The television display includes a wireless receiver 28 and interpreter which compares the signal with a table of functions and matches the signal received with the function requested. The requested function (e.g. raise or lower volume) is then carried out (as by routing more or less power to the speaker amplifiers). Such functions are well known in the art and not described further.

Certain keys of the remote control may be assigned certain functions. In the example described below, colored keys 32 are assigned (or re-assigned) certain program functions using a hotkey activator button 34. These colored keys 32 are also referred to as “hotkeys” because, and according to methods of the invention, they each trigger operation of certain programs that have been associated with the button (or more precisely, the remote control signal triggered by pressing the hotkey button).

Hot keys 32 are assigned to a particular function by first navigating to that function using whatever method is normally used to access the function, then pressing the <Hotkey> button 34 to request a hot key assignment, and then pressing the desired hot key to which the function will be assigned. The table of wireless signals received and functions performed that is stored at the television is updated to point to the new function. Any previous function which was already assigned to that button will no longer be assigned to the button. Only one function can be assigned to any one button, however, more than one button can have the same function assigned to it.

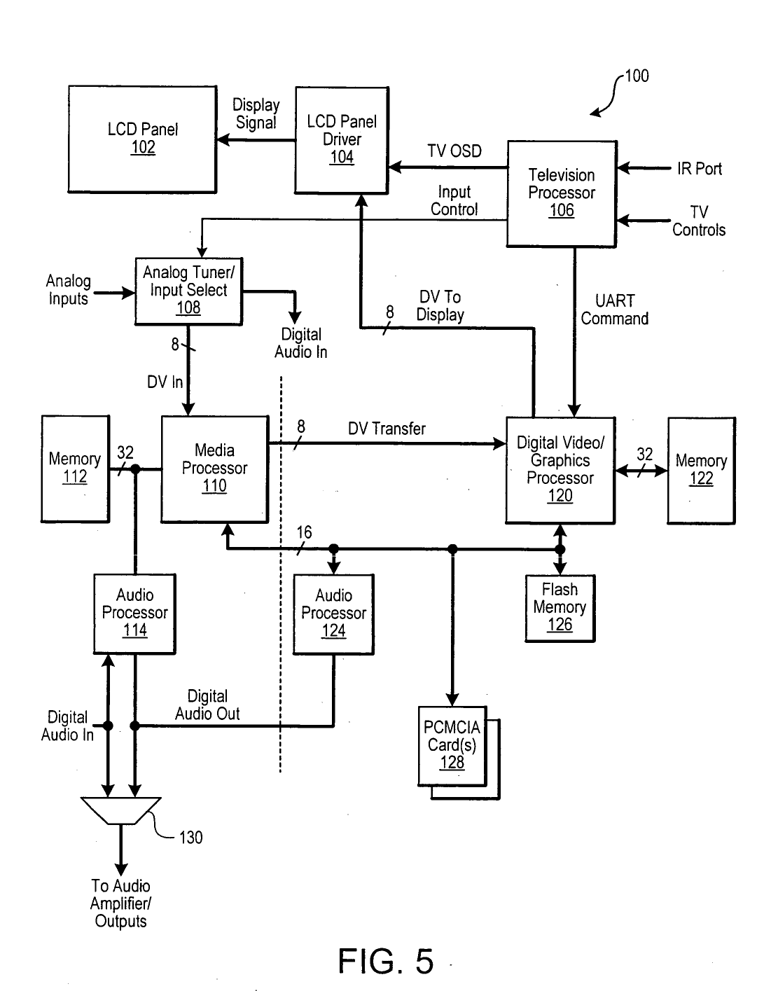

Hot keys are assigned to start a program via the Application Manager GUI (AMGUI). The application manager program is stored in flash memory 126 [FIG. 5] and run on the digital/video graphics processor (DVGP) 120 of television system 100. To assign a function, the user first enters the AMGUI by pressing the <[Apps]> button 36, then navigates to the desired program's icon and presses the <Hotkey> button 34. After pressing the <Hotkey> button, the hot key button screen appears, as shown in FIG. 4. The screen shows the icon 40 for the program currently being assigned to a hot key near the top of the screen. The current hot key assignment icons 42 are shown lower on the screen, with each hot key's currently assigned program or function icon displayed above a bar the color of the icon's assigned hot key. The user assigns the new program to a hot key by pressing the desired colored hot key—red, green, yellow, or blue. The user can press <Hotkey> button 30 to leave the hot key screen of FIG. 4, or any other OA key that brings up a different screen, i.e. <[Apps]> 36, <Menu> 38, or <Return> 39. After pressing the desired hot key 32, the hot key screen disappears and the function is now assigned to the pressed hot key signal.

Hot keys are assigned to program functions similarly to the method used to assign them to programs. The user navigates through the desired program and highlights the desired function. The user then presses the <Hotkey> button 34 and assigns the hot key 32 as described in the previous paragraph. If a program does not support a hot key for the desired function, a message is displayed on display 20 stating “Hot Key Not Supported”, to inform the user that the desired function does not support hot keys.

FIG. 5 contains a block diagram for a Liquid Crystal Display (LCD) television capable of operating according to some embodiments of the present invention. Television 100 contains an LCD panel 102 to display visual output to a viewer based on a display signal generated by an LCD panel driver 104. LCD panel driver 104 accepts a primary digital video signal in CCIR656 format (eight bits per pixel YC_{b}Cᵣ, in a “4:2:2” data ratio wherein two C_{b} and two Cᵣ pixels are supplied for every four luminance pixels) from a digital video/graphics processor 120.

A television processor 106 provides basic control functions and viewer input interfaces for television 100. Television processor 106 receives viewer commands, both from buttons located on the television itself (TV controls) and from a handheld remote control unit (not shown in FIG. 5, but like remote 22) through the IR Port. Based on the viewer commands, television processor 106 controls an analog tuner/input select section 108, and also supplies user inputs to a digital video/graphics processor 120 over a Universal Asynchronous Receiver/Transmitter (UART) command channel. Television processor 106 is also capable of generating basic On-Screen Display (OSD) graphics, e.g., indicating which input is selected, the current audio volume setting, etc. Television processor 106 supplies these OSD graphics as a TV OSD signal to LCD panel driver 104 for overlay on the display signal.

Analog tuner/input select section 108 allows television 100 to switch between various analog (or possibly digital) inputs for both video and audio. Video inputs can include a radio frequency (RF) signal carrying broadcast television, digital television, and/or high-definition television signals, NTSC video, S-Video, and/or RGB component video inputs, although various embodiments may not accept each of these signal types or may accept signals in other formats (such as PAL). The selected video input is converted to a digital data stream, DV In, in CCIR656 format and supplied to a media processor 110.

Analog tuner/input select section 108 also selects an audio source, digitizes that source if necessary, and supplies that digitized source as Digital Audio In to an Audio Processor 114 and a multiplexer 130. The audio source can be selected—independent of the current video source-as the audio channel(s) of a currently tuned RF television signal, stereophonic or monophonic audio connected to television 100 by audio jacks corresponding to a video input, or an internal microphone.

Media processor 110 and digital video/graphics processor 120 provide various digital feature capabilities for television 100, as will be explained further in the specific embodiments below. In some embodiments, processors 110 and 120 can be TMS320DM270 signal processors, available from Texas Instruments, Inc., Dallas, Tex. Digital video/graphics processor 120 functions as a master processor, and media processor 110 functions as a slave processor. Media processor 110 supplies digital video, either corresponding to DV In or to a decoded media stream from another source, to digital video/graphics processor 120 over a DV transfer bus.

Media processor 110 performs MPEG (Motion Picture Expert Group) coding and decoding of digital media streams for television 100, as instructed by digital video/graphics processor 120. A 32-bit-wide data bus connects memory 112, e.g., two 16-bit-wide×1M synchronous DRAM devices connected in parallel, to processor 110. An audio processor 114 also connects to this data bus to provide audio coding and decoding for media streams handled by media processor 110.

Digital video/graphics processor 120 coordinates (and/or implements) many of the digital features of television 100. A 32-bit-wide data bus connects memory 122, e.g., two 16-bit-wide×1M synchronous DRAM devices connected in parallel, to processor 120. A 16-bit-wide system bus connects processor 120 to media processor 110, an audio processor 124, flash memory 126, and removable PCMCIA cards 128. Flash memory 126 stores boot code, configuration data, executable code, and Java code for graphics applications, etc. PCMCIA cards 128 can provide extended media and/or application capability. Digital video/graphics processor 120 can pass data from the DV Transfer bus to LCD panel driver 104 as is, but processor 120 can also supercede, modify, or superimpose the DV Transfer signal with other content.

Multiplexer 130 provides audio output to the television amplifier and line outputs (not shown) from one of three sources. The first source is the current Digital Audio In stream from analog tuner/input select section 108. The second and third sources are the Digital Audio Outputs of audio processors 114 and 124. These two outputs are tied to the same input of multiplexer 130, since each audio processor is capable of tri-stating its output when it is not selected. In some embodiments, processors 114 and 124 can be TMS320VC5416 signal processors, available from Texas Instruments, Inc., Dallas, Tex.

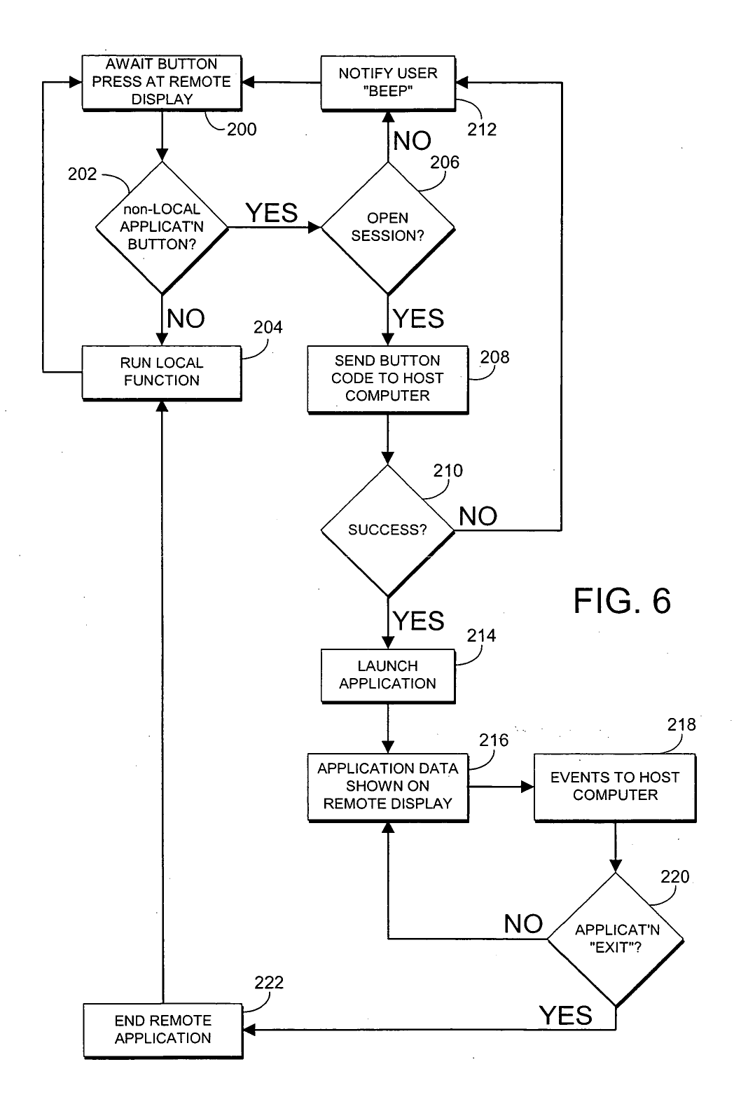

FIG. 6 illustrates the method steps performed by pressing one or more dedicated control buttons to directly access an application on a remote computer. In block 200, television processor 106 [FIG. 5] is in an idle state awaiting a button press at the remote display 20. Button presses of the remote control are detected through the IR Port coupled to the television processor or via buttons on the television console itself. A detected button press advances the process to query block 202 which determines whether the button press detected is a non-local application button. This may be accomplished by the lookup table stored in memory 112 as discussed above. For detections of button presses associated with local applications or functions, the process advances to block 204 where the local function is operated and the television processor again return to idle status in step 200. A detected press of a non-local application button advances the process to query block 206. The remote display is preprogrammed to recognize that this pressed button is associated with a non-local application and checks in query block 206 whether the remote display has an open remote display technology session with a host computer. If there is no open session, the display notifies the user in block 212 with a “beep” or some other means. Assuming that there is an open session, the remote display sends a unique code to the host computer in block 208 which indicates that the specific application button has been pressed. Upon receiving the signal from the remote display over the open session, the host computer responds immediately with a code from query block 210 indicating “success” (meaning the host computer is able to launch the application) or “error” (meaning the host computer does not recognize the unique code received or cannot otherwise launch the requested application) together with an audible cue such as a “beep” again in block 212.

If the host computer can successfully respond to the application request event, the application is launched in block 214 within the open session to generate display data in block 216 at the host computer. The remote display technology enables the host computer's display data to be shown on the remote display as appropriate, and routes future keyboard and mouse events in block 218 to the host computer as appropriate.

When the user is done with the application, the user may press “exit” (or some similarly labeled button) or may press a button which launches a local application. Such an “exit” button press is detected in query block 220. Upon such an exit action, the remote display notifies the host computer that the application is no longer needed, the remote display ceases to show the display data from the host, and mouse and keyboard events are sent to the local system. In the event that a local function is requested, the remote application can then be ended in block 222 and the local function operated in block 204. In the case that the user presses a button 32 requesting another non-local application, the request is sent to the host computer as before. If successful, the new application becomes active and the old application becomes inactive. If the host computer indicates that it cannot launch the new application, the user is notified (possibly with a “beep”), and the old application remains active.

The invention adds the following novel features. First, the buttons for direct application are on or associated with the remote display. The buttons may select remote applications, select local applications, and end applications. Also, the buttons may be on the remote control, on the device itself, or on a menu screen. Second, requests for applications originating with the remote display are sent to the host computer. Third, responses to the requests for applications result in either “success” or “error” (which may include multiple error codes, each indicating a specific reason for failure). Fourth, a novel feature of the invention is the ability of the host computer to recognize the application requests and to make the application active within the current remote display technology session. Fifth, the remote display is able to recognize responses. And sixth, the remote display is capable of switching between the local display mode and the remote display mode.

Television system 100 couples to a host computer as via a wireless local area network (LAN) PCMCIA card 128 operating using IEEE 802.11 g. In general, there would be a LAN adaptor that connects to the PCMCIA cards. It could be a PCMCIA card or an embedded set of chips. It could be wireless or wired, so long as the DVGP 120 [FIG. 5] can connect to the local area network.

There would be software pre-installed on the host computer which would be able to receive a command from the remote display using a socket or some other common means of network communication. The socket would have a pre-defined number for both the host computer and the remote display. The socket number may need to be user-changeable, in case there is a conflict with another socket from an application/service from the 3rd party. Even better: a series of numbers is used. If there is a conflict each side will check the next one in the series. That way a terminal conflict is highly unlikely, and no user intervention is required.

While the remote session is taking place, the remote display would then be able to send “a unique code” to the proprietary application or service running on the PC to the desired socket. The code or bit pattern would be the choice of the designer of the remote display and the application running on the host, as they are coded by the same entity. The specific protocol chosen is an implementation detail operating in a closed manner. The communication could be 100% proprietary. It could be as simple as a “1” means application 1, a “2” means application 2 and so on. This is reflected by the non-local keys 26 in FIG. 2.

Having described and illustrated the principles of the invention in a preferred embodiment thereof, it should be apparent that the invention could be modified in arrangement and detail without departing from such principles. We claim all modifications and variation coming within the spirit and scope of the following claims.

1. A system for activating and displaying an application on a display comprising:
a host computer having one or more applications operable thereon;
a remote display coupled to the host computer;
one or more buttons associated with and located at the remote display, each of said buttons further associated with an application operable on the host computer, whereby selection of the button at the remote display is communicated from the remote display to the host computer to cause activation of the application associated with the button selected; and
means for displaying display data on the remote display indicative of operation of the application on the host computer.

2. The system of claim 2, further including:
a wireless transmission device characterized by a remote control; the one or more buttons associated with and located at the remote display being included on the wireless transmission device, each of said buttons operable to activate a unique wireless transmission signal when pressed; and
a wireless receiver in electronic communication with the remote display and adapted to receive the unique wireless transmission signals from the wireless transmission device.

3. The system of claim 3, further including a hotkey manager program operable on the remote display and adapted to assign program functions to the one or more buttons.

4. A method for displaying an application, operable on a host computer, on a display remote from the host computer, comprising:
receiving button activation signals at the remote display;
sending the activation signals to the host computer associated with the button pressed;
operating an application responsive to receipt of the activation signals; and
displaying the application at the remote display.

5. The method of claim 4, further including the step of determining at the remote display whether an open session exists with the host computer and notifying a user at the remote display with an indicator signal if no open session currently exists.

6. The method of claim 4, further including the step of determining at the remote display whether an open session exists with the host computer and transmitting a unique code to the host computer corresponding to the activation signal.

7. The method of claim 6, further including the step of transmitting a code from the host computer to the remote display indicating “success” or “error”.

8. The method of claim 6, further including the step of ceasing to display the application at the remote display responsive to a user selection at the remote display.

9. The method of claim 6, further including the steps of receiving a second button activation signal at the remote display corresponding to a second application and displaying the second application in place of the original application at the remote display.
